(19) United States
(12) Patent Application Publication
(10) Pub. No.: US 2009/0083063 A1
(43) Pub. Date: Mar. 26, 2009

(54) System for Physician Directed Digital Medical Image Data Transmission Between Medical Institutions

(76) Inventors: Philip L. Johnson, Lakeside, AZ (US); Kenneth W. Batson, Clay Springs, AZ (US); Joe B. Dressler, Mustang, OK (US)

Correspondence Address: WILLIAM C. CAHILL, 155 PARK ONE, 2141 E. HIGHLAND AVENUE, PHOENIX, AZ, 85016, US

(21) Appl. No.: 11/778,814

(22) Filed: Jul. 17, 2007

Related U.S. Application Data
(60) Provisional application No. 60/942,552, filed on Jun. 7, 2007.

(51) Int. Cl. G06Q 50/00

(52) U.S. Cl. 705/2

(57) ABSTRACT

A system allows transmittal of digital medical images of patients being transferred from a sending medical institution to a receiving medical institution. The system uses institutional account passwords, physician specific passwords, and a patient specific digital imaging data code (PSDIDC). Digital medical imaging data is uploaded to the system website server by the sending medical physician through HIPAA compliant firewalls and VPN in standard digital formats including but not limited the DICOM format. The PSDIDC is generated by the website server after the data upload is complete and available only to the sending institution and physician. The PSDIDC is unique and is never used again. Using out-of-band communication, such as telephonic communication, the sending physician provides the PSDIDC to the receiving physician while both physicians may be logged on to the service website with their on site computers and passwords. Both physicians can simultaneously view and discuss the images while logged on to the service website. The digital medical imaging data may be downloaded through a VPN into the receiving medical institution archival system by the receiving physician to be used at the receiving institution in whatever manner deemed necessary to meet the patient's and institution's needs. The downloaded digital medical imaging data may subsequently be viewed by the receiving physician in the same resolution as if data originally obtained at that institution.

### FIELD OF THE INVENTION

The present invention relates to the transmission of medical image data and more particularly to the transmission of such data to facilitate the transfer of images between medical institutions pursuant to directions from sending and receiving physicians. The invention is particularly significant when the transfer of a patient becomes necessary to or from trauma centers wherein rapid decisions and patient transfer require the corresponding transfer of data images between institutions and physicians.

### BACKGROUND OF THE INVENTION

Most radiological data today is of digital nature, including computed tomography (CT), magnetic resonance (MR), positron emission tomography (PET), nuclear medicine, ultrasound, mammography, Dual-Energy X-ray Absorptiometry (DEXA,) radiography (x-ray) and fluoroscopy.

These diagnostic modalities have greatly improved diagnostic capabilities, but there is a problem when a patient is cared for by more that one institution. In the past, x-ray data was placed on a film and could be copied when a patient was sent from one facility to another for more specialized care. Most images are now digitally taken and placed on a Picture Archiving and Communication System (PACS) for viewing. One digital scan can be more than 250 images. Currently when one institution transfers a patient from one facility to another, the image is placed on a CD (compact disc), which is sent with the patient to the receiving institution. More often than not, when the patient arrives at the receiving facility, the images cannot be viewed off the CD or the resolution of data on the CD is too poor to effectively be read and the radiological scan is repeated.

Physicians can fax an EKG or typed patient records between institutions, but the often-suboptimal CD transferred with the patient limits the effectiveness of sending digital images between institutions. There are some institutions that have set up institutional agreements and have a Virtual Private Network (VPN) set up between institutions to enable transmittal of radiological digital data between them. The number of institutions with this arrangement is few compared to medical establishment as a whole. Transferring a patient for specialized care is a very complex process and it is not uncommon to call ten or more institutions to find an institution that has a bed available with the specialty care needed. The chance of transferring a patient from a facility to a facility with a VPN connection is extremely limited. Trauma surgeons at level I trauma centers frequently indicate that the digital CT scan is repeated because the data arriving on the CD with the patient is inadequate.

Thousands of scans are repeated unnecessarily because the digital data is not readable or suboptimal to the receiving physician. This causes millions of dollars of unnecessary redundancy with significant patient exposure to extra radiation. For example, exposure to a typical CT causes between 2 and 6 mSv of radiation. Though the risk of cancer from one scan is low, it is very much present. Exposing one patient to an extra chest CT is the equivalent to exposing them to 200 chest x-rays. Exposing a 40 year old to a chest CT gives the patient a 1 in 500 chance of developing cancer from the CT scan alone. If utilized, this invention will obviate the need for extra CT scans and reduce unnecessary exposure to radiation.

Apart from cancer, unnecessary radiation has been found to cause other health problems; for example, repeated CT scans have been found to increase the incidence of cataracts.

Significant valuable time is also lost in care of an emergent patient condition while the digital image is repeated. Further time is lost in waiting for a reading of the digital data. The present invention will be lifesaving with regard to time, as the accepting physician can read the scan off the website at any computer that can access the web. Often this will dictate much better care before the patient is transferred. The receiving physician will often know immediately what lifesaving operation is needed by directly viewing the scan on line versus being told about the scan over the phone. The operating room and necessary equipment can be prepared while the patient is in route to the receiving institution. Time is a critical factor when caring for the trauma patient. This invention can potentially save significant and vital life saving time by eliminating the time required to repeat and read unnecessary scans.

Cost containment is a very important issue with health care. When there is a trade off between quality of scan to provide the best care for the immediate patient problem, the repeat scan is always done. This invention will help the health care system not only with better care but potentially save the system millions of dollars as the scan sent to the institution for use in its PACS system is the same quality as if the scan were taken at the receiving institution.

The Health Insurance Portability and Accountability Act (HIPAA) ensures that patient data is only communicated between physicians and health care providers caring for that patient. This invention's web based transfer system ensures HIPAA compliance and utilizes HIPAA compliant methods of transferring digital data between institutions and a server. To sign on to this service an institution will have to agree to a HIPAA statement mandating the institution maintain HIPAA compliance to ensure patient confidentiality.

HIPAA requires that the Department of Health and Human Services adopt uniform security standards for sensitive health care information. The Health Care Financing Administration's (HCFA) Internet Security Policy outlines explicit requirements for VPN security. HCFA's policy satisfies the demanding Privacy act of 1974, which requires that federal information systems protect the confidentiality of individually-identifiable data. As such, the policy serves as the foundation for future efforts involving VPN-based applications for the health care industry. HCFA specifications conform to the three P's of VPN security. “Technologies that allow users to prove they are who they say then are [proof of identity] (authentication or identification) and the organized scrambling of data [privacy of information] (encryption to avoid inappropriate disclosure or modification) must be used to ensure that data travels safely on the Internet and is only disclosed to authorized parties. It is permissible to use the Internet for transmission of HCFA Privacy Act-protected and/or other sensitive HCFA information, as long as an acceptable method of encryption is utilized to provide for confidentiality and integrity of this data, and that authentication or identification procedures are employed to assure that both the sender and recipient of the data are known to each other and are authorized to receive and decrypt such information.” (HCFA Internet Security Policy) The HCFA guidelines permit three alternatives or their equivalents for encryption; Triple DES (Defined as 112-bit equivalent) for symmetric encryption, 1024-bit algorithms for asymmetric encryption, or 160-bit elliptical curve forms of encryption. This invention utilizes a HCFA approved VPH encryption.

Firewalls [protection of resources] are also recognized as being essential in the HCFA policy. This invention utilizes HCFA approved firewalls.

The invention links any hospital with an institutional password to another participating institution. Thus, this invention, for the first time, makes it possible to send digital patient radiographic data linking any sending institution to any receiving institution for the purposes of transferring a patient with the ability to view the image, download the image, and purge the image from storage after an agreed upon number of days.

The invention generates a Patient Specific Digital Imaging Data Code (PSDIDC) which is unique, and is composed of sending and receiving institution identifiers, specific patient identifiers, specific sending physician modifiers and a randomly generated string of characters; the combinations of which are never used again,

This invention mandates a series of institutional passwords be set up when signing up to the service. The patient PSDIDC is generated and is linked to only the sending institution, which can be communicated to the receiving physician like any other patient data that is needed by the receiving institution. Thus, a patient PSDIDC can only be used and viewed at the sending institution and receiving institution at the discretion of the sending provider, similar to the way any medical record is treated per HIPAA guidelines.

### SUMMARY OF THE INVENTION

The invention is a system and method whereby a sending physician can choose to send a patients digital medical image from the sending institution to a receiving institution with the ability of a receiving physician to view the medical image on the website. This is accomplished by sending the digital image with appropriate patient modifiers of name and birthday (a system is in place to give a Jane Doe equivalent name and a birth date in the emergent medical situation when no patient name is known) to the website. The sending institution, and sending physician's name is also attached to the record and the digital data is sent to the website via a HIPAA compliant firewall and VPN connection. The data being sent by the sending institution would normally be formatted in Digital Imaging and Communications in Medicine (DICOM), a standard developed by the American College of Radiology Manufacturers Association.

Once the image arrives at the website the system of the present invention stores the data in a database and creates a PSDIDC which is unique and is composed of sending institutional modifiers, sending physician modifiers, specific patient modifiers, a randomly generated string of characters, later to be linked to receiving institution modifiers, the combinations of which will never be used again.

The PSDIDC is available only to the sending physician and sending institution. The sending physician can enter the website with an institutional and personal password. The PSDIDC will then and only then be available. The sending physician views the digital medical image on the website, verifies that it is indeed the scan of the patient in question. The sending physician then calls the accepting or receiving physician by phone and relays the PSDIDC.

The receiving physician can access the website via an institutional level username and password. Then the physician must use a personal user name and password to access patient data. Once this personal logon has been entered a patient list is generated on the patient list screen. If this is the first time the invention has been used, there would be no patients listed. At any time, the physician would be able to enter the PSDIDC into a field on the screen, unlocking the patient record and placing it in the list. The physician would then be able to open the patient record and access the digital medical image with a provided image viewer.

The patient image on the website can be compressed to enable faster access with the image viewer. This is very helpful but does not provide the quality that can be obtained once the digital data is downloaded to the receiving institution and ultimately viewed on that institutional radiology system. It does however enable sending physician and receiving physician to view, simultaneously if needed, the image available through the website real time and enable physician-to-physician discussion while viewing the image, thus providing much better care for the patient.

The receiving physician can choose to send the original digital image file to the receiving institution's radiology or image storage system by selecting a download option on the patient list screen indicating to the system that the image should be downloaded to the appropriate department of the receiving institution. The invention will then send the original DICOM (or other digital image) to the receiving institution via a HIPAA compliant VPN connection and firewall at the receiving institution. The invention will send the image to, and only to, the receiving institution. The receiving institution will add institutional modifiers to the image such as a medical record number and whatever is needed by that institution. This data can then be saved and manipulated like any image taken on site at the receiving institution. This completes the loop of sending the image and enables the receiving physician access to the patient's medical image as if it were taken at the receiving institution.

The website then purges the patient record and corresponding digital data per the institutions agreement.

In the event that an accepting institution is not setup with the required VPN connection that allows the receipt of the digital data, the invention will enable a guest account with a view only mode that will enable a receiving physician to enter a PSDIDC for Web only viewing.

### BRIEF DESCRIPTION OF THE DRAWINGS

FIG. 1 is a flow diagram depicting institutional sign up.

FIG. 2 is a diagram depicting the system elements and method involved in taking the patient medical image, adding appropriate patient, physician, and institutional indicators and sending the image to data storage via the website.

FIG. 3 is a diagram depicting the system elements and the method involved in digital image storage, PSDIDC creation, and link between sending institution and receiving institution with the sending and receiving physicians.

FIG. 4 is a flow diagram depicting the elements and the method within the website to create PSDIDC, enable viewing image on line of sending and receiving physicians, link sending and receiving institutions with sending of digital patient image and confirmation feedback loop.

FIG. 5 is a flow diagram depicting the elements and the method of creation of a guest physician user pathway.

### DESCRIPTION OF THE PREFERRED EMBODIMENT

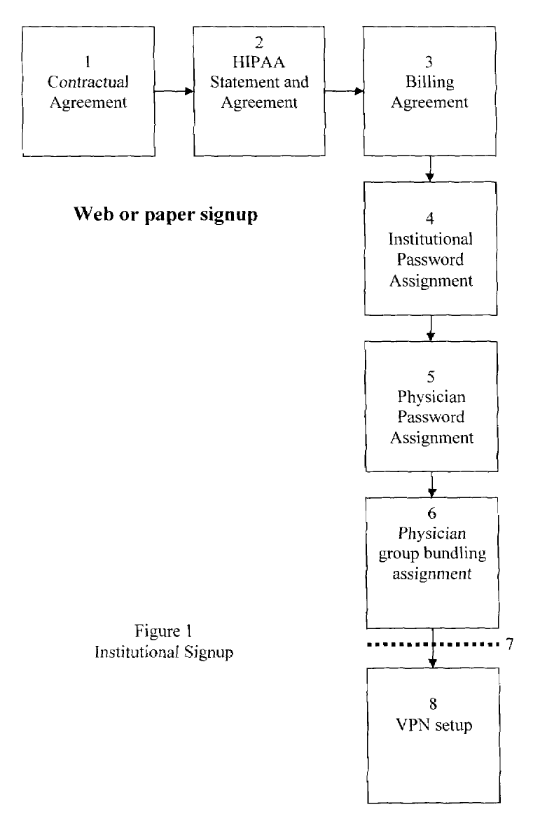

Institutional agreements 1, 2 and 3 are depicted in FIG. 1, and are created as a part of the formation of an institutional group. This can be accomplished via web or on paper. Institution passwords assignment 4, physician passwords assignment 5, physician bundling assignment 6 are accomplished at this time. Institution appropriate HCFA compliant firewall 7 is reviewed and set up if need be. VPN 8 is set up with the website with firewall 7 at the sending institution end.

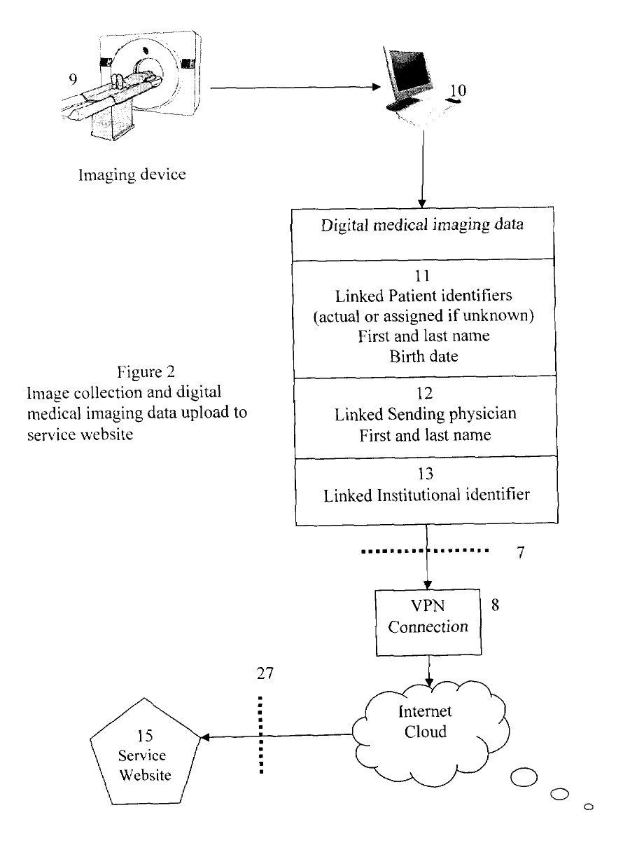

Referring to FIG. 2 the patient receives a CT, MRI, or digital image scan 9. This image is controlled by computer 10. Once the sending physician chooses to transfer the patient to another institution, the website is chosen on computer 10, patient name and birth date (actual or assigned) 11 is attached, sending physician name 12, institution identifier 13 is added and sent to a data base or other data storage facility accessable through the website via HCFA and HIPAA compliant firewall 7 and VPN 8.

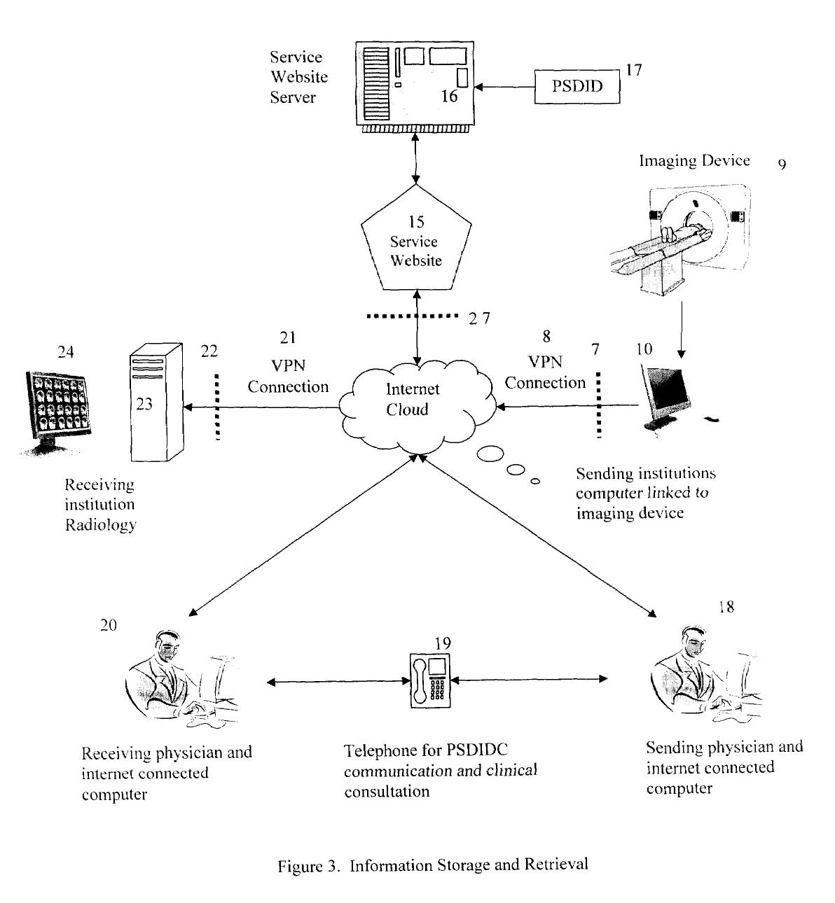

Referring now to FIG. 3, the storage facility receives the digital image and stores the information in the server 16. The database program generates a PSDIDC based on an algorithm that selects a random but unique alphanumeric key and assigns it to the patient record 17, enables a digital image to be available for viewing by the sending physician 18 upon logging onto the website 15 and entering institution and physician passwords. The sending physician 18 opens the file and views the file online and authenticates data. The sending physician 18 then calls the receiving physician 20 and communicates the PSDIDC over the phone 19. The receiving physician 20 can then access the stored image for viewing through the website, review the patient digital images, can communicate with the sending physician 18 regarding the images and any further treatment needed prior to transfer. The receiving physician 20 confirms the digital image and downloads it to the receiving institution via a HCFA and HIPAA compliant VPN 21 and firewall 22. The receiving institution can then add their institution modifiers such as medical record number and can transfer the data to their PACS system for future retrieval and use 24. Note that the VPN transmissions to and from storage 16 is a direct data transmission not limited to the parameters of the website although the website provides access to the stored data and provides a means for directing the data to a desired receiving institution. The data thus transmitted over the VPN will provide high quality images to the receiving institution that may not be available in such high resolution when received via the website.

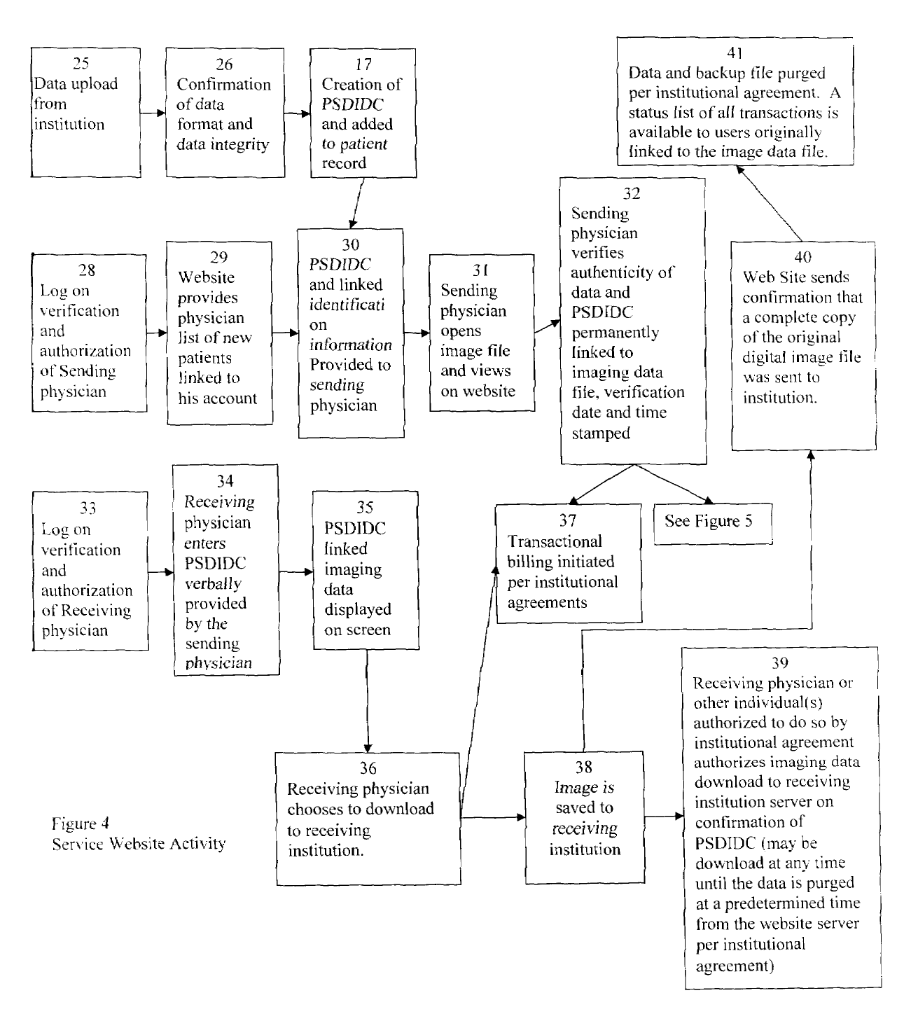

Referring to FIG. 4 in combination with FIG. 3, FIG. 4 depicts data flow including website data flow shown in accordance with the teachings of the present invention. Once the digital image arrives at the storage facility from the sending institution, the image is stored in the database with the patient information. A PSDIDC is created and stored in the patient record 17. PSDIDC linked image is stored in the storage facility or server 16. The sending physician verifies the image and patient record and authorizes the PSDIDC for use 28. Sending physician 18 verifies the PSDIDC to the specific patient image 30 and opens the image file for viewing. The sending physician also verifies date and time stamp of the file 32 to ensure proper identification of patient, image, PSDIDC, and accompanying data. The receiving physician 20 logs on with institution and physician passwords 33 and enters the patient PSDIDC 34 that has been communicated to him by the sending physician by telephone 19. The selected image is displayed to receiving physician 35 and may choose to download the image to the receiving institution 36. After the receiving institution download is complete 38, the website will keep receipt of the download transaction and send receipt to receiving institution 40, after an agreed upon time with the institution the website will purge the system of the medical image and PSDIDC 41.

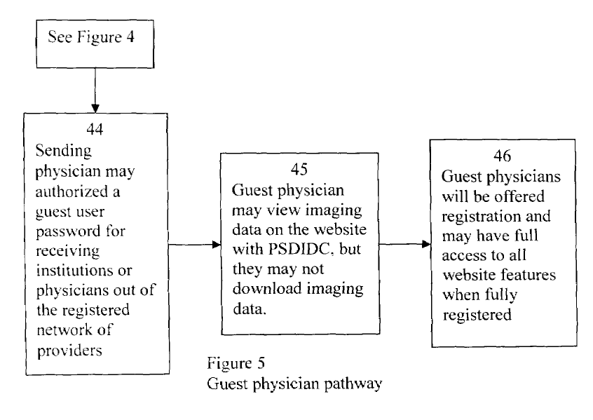

FIG. 5 depicts the ability of the sending physician to give a receiving physician a guest account and password obtained on the website 41. Under some circumstances, there may be an institution that is not signed up to receive the image download but may be the only institution that can accept a patient at that time. The accepting physician or surgeon will obviously want to see images prior to transfer or at sometime before the patient arrives. This accepting surgeon or physician is given a guest account so that the receiving physician may observe the image via the website. The sending physician then gives the guest receiving physician the PSDIDC which is entered and the guest physician can access the patient medical image 45. The guest receiving physician may not download the imaging data 45. The receiving guest physician will be offered registration to permit full access to all website features when fully registered 46.

What is claimed is:

1. A system for physician directed digital medical image transmission comprising:
(a) means for creating a digital image scan to produce a digital image associated with a patient;
(b) storage means connected through a VPN to said means for creating for receiving said digital image and for appending a unique patient identifier thereto;
(c) said digital image accessible through a website to be viewed by a sending physician and a receiving physician;
(d) communication means, accessible by a sending physician and a receiving physician to permit communication between them; and
(e) a receiving institution storage means connected through a second VPN to receive and store said digital image at said receiving institution.

2. The system of claim 1 wherein said communication means is a means for oral communication.

3. The system of claim 1 wherein said communication means is a telephone.

4. The system of claim 1 wherein said means for creating includes one of CT, MR, PET, nuclear medicine, ultrasound, mammography, DEXA, X-ray and fluoroscopy modalities.

5. The system of claim 1 wherein said storage means is a web server.

6. In a system for directing digital medical images from a sending institution to a receiving institution, the improvement comprising:
(a) a website having a website server accessible to the sending and receiving institutions;
(b) a VPN including the sending institution and website server for transmitting digital medical images for storage in said website server;
(c) a second VPN including the receiving institution and website server for transmitting stored digital medical images to said receiving institution; and
(d) said website server responsive to the receipt of a digital medical image for creating a unique patient identifier code appended to the image to inhibit access to the image to inquiries not having the code.

7. The improvement of claim 6 including a communications means between said sending institution and said receiving institution to permit communication between a sending physician and a receiving physician.

8. The improvement of claim 7 wherein said communication means is an oral communication means.

9. The system of claim 7 wherein said communication means is a telephone.

10. Method for physician directed digital medical image transmission comprising:
(a) creating a medical digital image associated with a patient;
(b) transmitting said medical digital image via a VPN to a storage system in response to directions from a sending physician;
(c) assigning a patient specific code to the medical digital image when the image is stored;
(d) providing said patient specific code to the sending physician;
(e) providing communication from the sending physician to a receiving physician;
(f) transmitting said patent specific code from said sending physician to said receiving physician; and
(g) providing access by the receiving physician having said patient specific code to said storage system to view said medical digital image.

11. The method of claim 10 wherein said digital image is created by one of CT, MR, PET, nuclear medicine, ultrasound, mammography, DEXA, X-ray and fluoroscopy modalities.

12. The method of claim 10 including transmitting said medical digital image via a second VPN to a receiving institution.

13. The method of claim 10 including simultaneously viewing said medical digital image by the receiving physician and sending physician on respective viewers while engaging in communication concerning the image.

14. The method of claim 10 including transmitting said medical digital image via a second VPN to a receiving institution and simultaneously viewing said medical digital image by the receiving physician and sending physician on respective viewers while engaging in communication concerning the image.

15. The method of claim 14 wherein said digital image is created by one of CT, MR, PET, nuclear medicine, ultrasound, mammography, DEXA, X-ray and fluoroscopy modalities.

16. Method for physician directed digital medical image transmission comprising:
(a) creating a website having a web server;
(b) creating a medical digital image associated with a patient;
(c) transmitting said medical digital image via a VPN to said web server in response to directions from a sending physician;
(d) assigning a patient specific code to the medical digital image when the image is stored;
(e) accessing said web server through said website to verify said medical digital image and acquire said patient specific code for sending physician's use;
(f) providing communication from the sending physician to a receiving physician;
(g) transmitting said patent specific code from said sending physician to said receiving physician; and
(h) providing access through said web by the receiving physician having said patient specific code to said storage system to view said medical digital image.

17. The method of claim 16 wherein said digital image is created by one of CT, MR, PET, nuclear medicine, ultrasound, mammography, DEXA, X-ray and fluoroscopy modalities.

18. The method of claim 16 including transmitting said medical digital image via a second VPN to a receiving institution.

19. The method of claim 16 including simultaneously viewing said medical digital image by the receiving physician and sending physician on respective viewers while engaging in communication concerning the image.

20. The method of claim 16 including transmitting said medical digital image via a second VPN to a receiving institution and simultaneously viewing said medical digital image by the receiving physician and sending physician on respective viewers while engaging in communication concerning the image.

21. The method of claim 20 wherein said digital image is created by one of CT, MR, PET, nuclear medicine, ultrasound, mammography, DEXA, X-ray and fluoroscopy modalities
